(19) United States
(12) Patent Application Publication
(10) Pub. No.: US 2002/0089712 A1
(43) Pub. Date: Jul. 11, 2002

(54) Routing table configuration for MPlambdaS (multi-protocol lambda switching) protection and restoration in optical mesh networks

(76) Inventors: Min Ho Kang, Taejon (KR); Jung Yul Choi, Taejon (KR); Byung Jae Kim, Taejon (KR)

Correspondence Address: BACON & THOMAS, PLLC, 625 Slaters Lane - 4th Floor, Alexandria, VA, 22314-1176, US

(21) Appl. No.: 09/781,290

(22) Filed: Feb. 13, 2001

(30) Foreign Application Priority Data
Jan. 10, 2001 (KR) 10-2001-01252

(51) Int. Cl. H04B 10/08; H04B 10/20; H04J 14/00

(52) U.S. Cl. 359/110; 359/118

(57) ABSTRACT

The present invention relates to protection and restoration method for MPXS in optical mesh networks, particularly to protection and restoration method which can find and restore fast failures by configuring routing table with working label and protection label when failures occur at links or nodes.

According to the present invention, by configuring a routing table consisted of working label and protection label and by setting an optical path as working path and protection path, data is transferred through the working path, and when a failure occurs in a optical path, data is transferred through a protection path by using a preliminarily configured protection label and by switching to.

According to the present invention, by configuring routing table with working label and protection label, failures can be restored fast when failures occur at links or nodes, and whole network resources can be applicable.

### BACKGROUND OF THE INVENTION

1. Field of the Invention

The present invention relates to a protection and restoration method for MPXS in optical mesh networks, particularly to a protection and restoration method which can find and restore fast failures by configuring routing table with a working label and a protection label synchronously when failures occur at links or nodes.

2. Description of the Related Art

As Internet data traffic is increasing dramatically, a transfer ability of the conventional networks is going to its limit.

Recently, an intellectual optical networks is showing up based on the Wavelength Division Multiplexing(WDM).

A preliminary protection and restoration method against a failure is indispensable in optical mesh networks which transfer massive amount of traffic.

Protection in optical mesh networks is performed in several layers. In layer 3 using routing protocols, when a failure occurs in networks, rerouting is newly performed. Therefore, it takes more time to recover from failures due to rerouting. This protection method is very robust and survivable. Synchronous Digital Hierarchy (SDH) used in the conventional optical networks acts against and restore a failure fast. Protection method in SDH is appropriate for a point to point structure or a ring structure, but is not sufficient for using in optical mesh networks.

### SUMMARY OF THE INVENTION

When evaluating an overall performance in protection method, restoration time and efficient resource utilization are two most important parameters.

First, in link protection, the two nodes located at each end, which detect a failure first, are responsible for protection against a failure. Here, protection method such as 1+1, 1:1, 1+n, etc. is utilized. Because most closed nodes restore a failure after a failure occurs, a faster acting is possible.

Second, in path protection, the source nodes and destination nodes, which configure the path or perform protection and restoration, are responsible for protection against a failure not the two nodes located at each end. Therefore, if a failure occurs at any link, the two nodes located at each end should deliver the information about a failure to the nodes which have a restoration capability.

However, in link protection, because it is not possible to predict in which a failure occurs, preliminary link should be existed against all links in network. In path protection, it takes much time to restore a failure.

The present invention is to solve the said matters and to provide a protection and restoration method for MPS in optical mesh networks, which can find and restore fast failures by configuring routing table with working label and protection label synchronously when failures occur at links or nodes, to harmonize protection skills among the diverse layers and to protect MPXS.

To reach the said purpose, the present invention configures routing table, which is configured by routing protocols, with working label and protection label and sets an optical path as an working path and a protection path so that data is guided to pass through the said working path and to be switched using a preliminarily configured protection label to pass through a protection path when a failure occurs in an optical path.

### BRIEF DESCRIPTION OF THE DRAWINGS

FIG. 1 shows routing table configuration according to the present invention.

FIG. 2 shows restoration method when failures occur in routing table according to the present invention.

### BRIEF DESCRIPTION OF THE NUMERIC OF DRAWINGS

10: Routing Table

20a, 30a: Input Port

20c, 30c: Output Port

30: Protection Label

42: Control Channel

52: Data Channel

#1, . . . , #5: Link Number

20: Working Label

20b, 30b: Input Wavelength ID

20d, 30d: Output Wavelength ID

40: Router

50: OXC

λ1, λ2, λ3: Optical Path

A, . . . , D, G, . . . , L: Node(s)

### DETAILED DESCRIPTION OF THE EMBODIMENTS

To help to understand the present invention, explanation of MPS comes firstly.

Fast and efficient configuring is indispensable when the need for optical path configuring occurs in optical networks. Also, when a failure occurs at nodes or in links, the skill to find and manage the failure is indispensable.

To manage and control efficiently the said diverse needs occurred in networks, MPAS (Multi-Protocol Lambda Switching) is proposed. The said MPAS is proposed in IETF, in the year 1999.

MPλS is used to configure control plane of optical networks based on traffic engineering skill using LDP(Label Distribution Protocol) or RSVP(Resource Reservation Protocol).

MPλS networks place OXC(Optical Cross Connector) on core networks and configure edge networks with a high speed IP router.

MPλS uses label to apply high speed switching skill like MPLS. In this time, optical label is used, which can be considered wavelength, instead of placing directly label on packet.

The said optical label is configured with port ID and wavelength ID.

Nodes in core networks used the diverse control message like notice, initializing, asking label, mapping label, cancellation label, etc. to configure an optical path.

The said control message can be transferred through independent control channel and/or through data channel.

It is needed to configure routing table by routing protocols to configure the control plane using MPAS.

IS-IS, OSPF, etc. can be applied as the said routing protocols, and it is needed to be modified according to the characteristics of optical networks.

An optical path can be configured based on a routing table configured by routing protocols.

Signaling protocol is used to configure an actual optical path.

CR-LDP(Constraint-based Label Distribution Protocol) or RSVP-TE(Resource Reservation Protocol-Traffic Engineering) can be applied as a signal protocol.

Hereafter, the present invention is described in detail by referring to accompanying drawings.

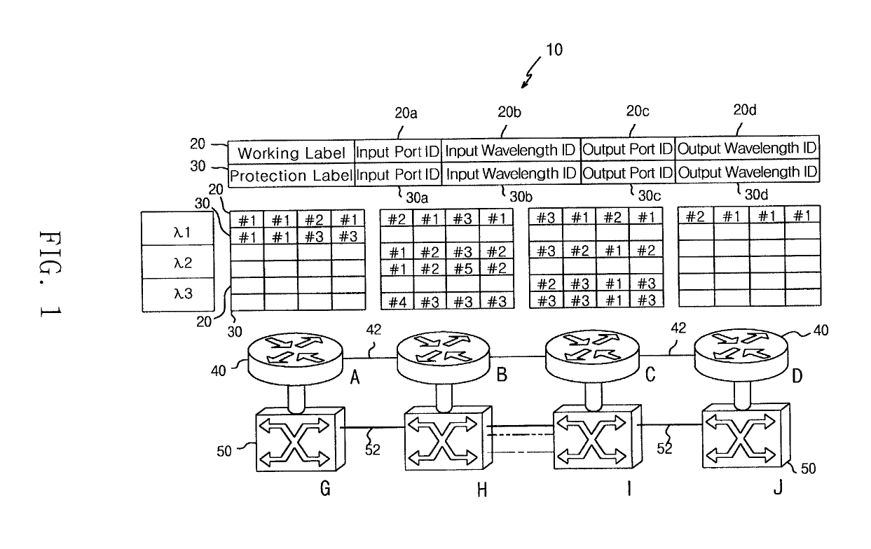

FIG. 1 shows routing table configuration according to the present invention.

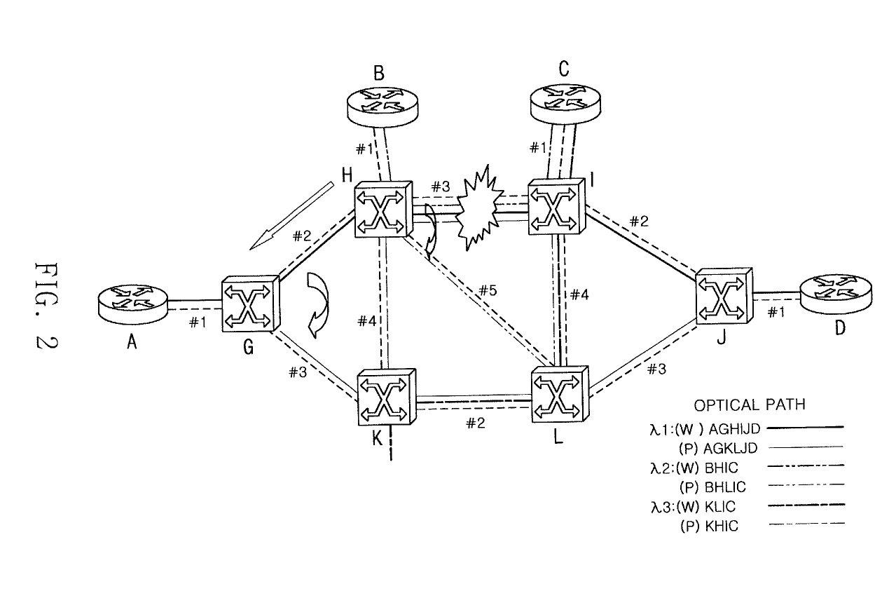

FIG. 2 shows restoration method when failures occur in routing table according to the present invention.

The present invention configures routing table (10) with working label (20) and protection label (30), which is configured by routing protocols and sets an optical path as an working path and a protection path so that data is guided to pass through the said working path and to be switched using preliminarily configured protection label (30) to pass through protection path when a failure occurs in an optical path.

Routing table (10) configures working label (20) and protection label(30) synchronously.

In other words, two paths(working path and protection path) are set for an optical path, and actual data is transferred through the working path.

If a failure occurs in the optical path, actual data is switched to protection path using preliminarily configured protection label(30).

It is possible because a protection path is configured preliminarily.

Each optical label (20, 30) has information about an optical path to allow to be switched in OXC (50) and is configured with 4 ID which are input port ID (20a, 30a), input wavelength ID (20b, 30b), output port ID (20c, 30c), and output wavelength ID (20d, 30d).

Optical path is configured based on the said optical labels (20,30) configured with the said 4 ID.

According to the present invention, optical path in routing table (10) is configured using signaling protocol by configuring working label (20) and protection label (30) synchronously when the conventional routing protocol is configured.

The numeric signal 40 is a router configured in edge networks of MPλS networks, and the numeric signal 30 is an OXC (Optical Cross Connector) set in core networks.

The numeric signal 42 is a control channel, 52 is a data channel, and #1, . . . , #5 are link numbers.

Protection and restoration method based on routing table of FIG. 1 and referred to FIG. 2 is described.

Usually, traffic is transferred from node(A) to node (D) through optical path (λ1:node A-G-H-I-J-D) which uses working label (20).

In FIG. 2, W and P mean each of a working path and a protection path of an optical path.

Hereafter, the case that a failure occurs at links between nod (H) and node (I) is as followings.

Optical path (λ 2), which starts node B and passes nods H and I, and then goes to node C has protection path for nodes H and I in routing table (10) which placed at node H.

Therefore, a failure in node H can be restored fast only by switching to protection path for optical path (λ 2) so that optical path can go to node C by passing nodes H, L, and I.

However, there is not preliminary path for optical paths (λ 1: nodes A-G-H-I-J-D).

Therefore, the signal of a failure is transferred to origin node of optical path (λ 1) from node H.

In optical path λ 1, node G has restoration capability. So, node G switches to the preliminary path (node G-K-L-J-D) after confirming existence of protection label (30) for optical path (λ 1) in the routing table after receiving a failure signal.

Protection path is predicted so that restoration path is formed only with confirming protection label (30) without calculating another path upon protection path is formed.

As described herein, to apply a protection method based on MPλS according to the present invention, protection is predicted to restore a failure fast, and path protection method is used to apply efficiently sources in networks when a failure occurred.

The present invention allows the total networks sources to be applied efficiently and failures to be sources to be applied efficiently and failures to be restored fast when failures occur at links or nodes by configuring routing table, which is configured by routing protocols, with working label and protection label.

What is claimed is:

1. Protection and restoration method for MPS in optical mesh networks wherein a routing table is configured synchronously, which is configured by routing protocols, with working label and protection label and sets an optical path as an working path and a protection path so that data is guided to pass through the said working path and to be switched using preliminarily configured protection label to pass through a protection path when failures occur in an optical path.
